(19) United States
(12) Patent Application Publication
(10) Pub. No.: US 2018/0098592 A1
(43) Pub. Date: Apr. 12, 2018

(54) MOTORCYCLE HELMET

(71) Applicant: Freddie Lee Figgers, Tallahassee, FL (US)

(72) Inventor: Freddie Figgers, Tallahassee, FL (US)

(73) Assignee: Freddie Lee Figgers, Tallahassee, FL (US)

(21) Appl. No.: 15/472,465

(22) Filed: Mar. 29, 2017

Related U.S. Application Data
(60) Provisional application No. 62/407,145, filed on Oct. 12, 2016.

(51) Int. Cl. A42B 3/04; A42B 3/24; A42B 3/08; A42B 3/30; A42B 3/28; A42B 3/06; A42B 3/12; H04N 5/232; H04N 7/18; G02B 27/01

(52) U.S. Cl. CPC A42B 3/0426; A42B 3/24; A42B 3/08; A42B 3/303; G02B 27/0176; A42B 3/066; A42B 3/12; H04N 5/23238; H04N 7/185; A42B 3/283

(57) ABSTRACT

The present invention relates generally to display systems for helmets and in particular for display systems for motorcycle helmets.

### FIELD OF THE INVENTION

The present invention relates generally to display systems for helmets and in particular for display systems for motorcycle helmets.

### BACKGROUND OF THE INVENTION

Heads-up display is a display of instrument readings in an aircraft or vehicle that can be seen without lowering the eyes, typically through being projected on to the windscreen or visor. Heads-up displays have been suggested for implementation in a multitude of transportation applications including automobiles, aircraft and motorcycles. A typical heads-up display comprises of three primary components: a projector unit, a combiner, and a video generation computer. The projection unit in a typical heads-up display is an optical collimator setup having a convex lens or concave mirror with a Cathode Ray Tube, light emitting diode, or liquid crystal display at its focus.

The combiner is typically an angled flat piece of glass called a beam splitter which is located directly in front of the viewer that redirects the projected image from projector in such a way as to see the field of view and the projected infinity image at the same time. Combiners may have special coatings that reflect the monochromatic light projected onto it from the projector unit while allowing all other wavelengths of light to pass through.

A motorcycle helmet has to provide adequate deceleration for the human brain in massive impacts. In order to protect the head from the massive impact, various densities of styrofoam are layered between the motorist's head and the outer shell. The helmet is made from a strong material like carbon fiber or plastic, that shell deflects impacts and spreads their energy over a large area.

One of the biggest considerations in motorcycle helmet design is in delivering good crash protection in a package with the smallest possible external dimensions. The smaller a helmet is, overall, the more aerodynamic it will be, and the lower the force with which it may twist a user's head and neck. Heavier helmets also cause muscle fatigue and soreness.

Unlike micro displays, a real heads-up display works by projecting an image onto a clear surface in front of the eyes of the user. In this process, it overlays data on vision, without the wearer having to change his focal point. By making the projected image appear as if it's floating way out in front of you, you can see it without changing the focal distance of your eyes. A real heads-up display empowers users with data in a un-distractive way.

For motorcycles, however, installing a beam splitter in the limited space between the rider's face and the helmet windscreen presents significant design obstacles. Therefore, just sticking a set of big optics and a computer in an existing motorcycle helmet is not the solution to the problem. Also if more information has to be displayed, then there is requirement for increased processor speed and power consumption which is necessary to accommodate the demands. If the above has to be achieved in a wireless environment, then there is a requirement for larger and heavier batteries pack.

Hence there is a need for a motorcycle helmet which is light weight with different advanced features that enhances the usability of the helmet.

### OBJECTS OF THE INVENTION

The primary objective of the present invention is to provide a motorcycle helmet with heads-up display.

Another objective of the present invention is to provide a motorcycle helmet with 5 inch wide angle rear view camera.

Another objective of the present invention is to provide a motorcycle helmet with technologies like GPS navigation, Bluetooth technology, internet phone chipset, Global system for mobile communications (GSM) Sim card slot, integrated radio with audio and hands-free calling.

Another objective of the present invention is to provide a motorcycle helmet with 3 dimensional laser-cut foam for a perfect fit.

Another objective of the present invention is to provide a motorcycle helmet with anti-fog, anti-scratch and anti-glare visor.

### SUMMARY OF THE INVENTION

The present invention comprises of a motorcycle helmet having an augmented reality display. According to an illustrative embodiment, the helmet comprises of a full-face motorcycle helmet with heads up display. The motorcycle helmet comes with situational awareness feature wherein the motorcycle rider will be aware of the vehicles which are travelling along with him on the same road and at the same location. The helmet which is described in the present invention also comes with a five inch wide angle rear view camera which displays the live images of the scene behind the rider.

The helmet also includes some advanced technologies like the global positioning system (GPS) navigation which displays the position of the rider on the map along with the complete route map through which the rider can navigate through the location. The helmet is also featured with the Bluetooth technology, internet phone chipset, GSM Sim card slot, integrated radio, hands-free calling and Sirius XM radio. Sirius XM radio offers commercial-free music from every genre, live play-by-play sports, the biggest news and talk, and the hottest entertainment 24/7. The music can be heard at home or the office on the computer, or smartphone and tablet.

### BRIEF DESCRIPTION OF THE DRAWINGS

FIG. 1 of the present invention describes the side view of the motorcycle helmet.

FIG. 2 of the present invention describes the internal and outer parts of the helmet

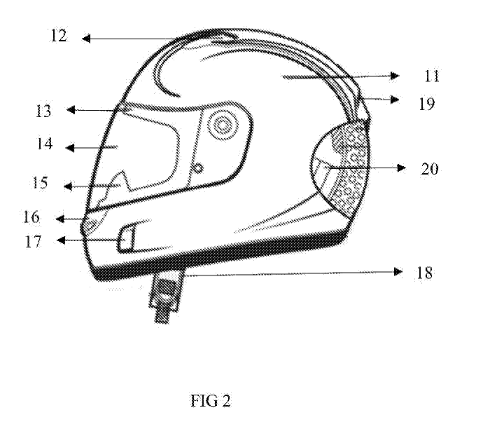

### DETAILED DESCRIPTION OF THE INVENTION

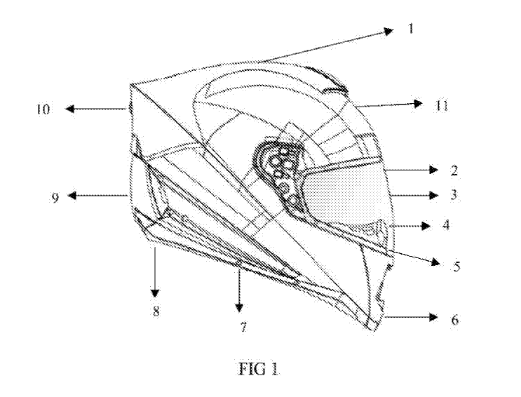

The present invention describes the motorcycle helmet with augmented display. FIG. 1 describes the motorcycle helmet with more advanced features. The motorcycle helmet is preferably constructed of conventional materials with an inner liner formed of expanded polystyrene or polypropylene foam (EPS) and an outer shell 11 made from a homogeneous plastic such as polyamide, polyethylene or polycarbonate, or from a composite material such as fiberglass, aramid, carbon fiber or other composites.

The motorcycle helmet includes a super vent 12, eye port gasket 13, conventional face shield 14, a breath deflector 15, a mouth vent 16, a side vent 17, a chin bar 18, rear vent 19, top pad 20, base gasket 21 and a chin strap 22. Chin bar 18 has a plurality of conventional ventilation intakes which are adjustable to allow a controlled amount of air to enter the helmet for the purpose of reducing fogging of face shield 14 in humid weather and/or for ventilation of the rider. The motorcycle helmet further includes a plurality vents like super vent 12, mouth vent 16, side vent 17, and rear vent 19 which are mainly used for air intakes and ventilation.

The motorcycle helmet includes a visor 2 which is scratch resistant, fog resistant and glare resistant which provides the rider with the clear vision of the vehicles which are moving forward. The helmet also includes an ultra-wide angle rear view camera 10 which captures the panorama view of the area behind the rider which can be enhanced and viewed by the motorcycle rider with the help of the synapse vision enhancement 3 feature which true to life imaging of the rear view panorama display.

The motorcycle helmet includes a visor 2 which is scratch resistant, fog resistant and glare resistant which provides the rider with the clear vision of the vehicles which are moving forward. The helmet also includes an ultra-wide angle rear view camera 10 which captures the panorama view of the area behind the rider which can be enhanced and viewed by the motorcycle rider with the help of the synapse vision enhancement 3 feature which true to life imaging of the rear view panorama display.

The motorcycle helmet is provided with the device which helps in the audio/visual GPS navigation system 4 which displays the location and position of the rider when he is travelling. The display device which is the synapse smart heads-up display system 5 preferably comprises a virtual image display unit consisting of a liquid crystal display (LCD), backlight, collimating optics and magnification optics encased in a single device. In the illustrative embodiment, the VID unit comprises of a 0.59″ WVGA CyberDisplay® display unit manufactured by Kopin Corporation of Westboro, Mass. The motorcycle helmet also comprises of the quick release chin strap 18 which enables the rider to quickly fasten and release the helmet.

The motorcycle helmet is made of 3D laser cut foam 8 with superior quality which gives the rider's head a perfect fit inside the helmet. Also the helmet is provided with a fabric liner 20 for superior comfort. The helmet is certified by the Department of Transport (DOT) and the United Nations Economic Commissions of Europe (ECE) that the helmet is meeting the standard helmet specifications which can protect the rider as the main aim of the helmet is for head protection. The helmet is also provided with additional features like Bluetooth technology which can connect the helmet with other devices through Bluetooth, Internet phone Chipset, GSM SIM card slot in which a SIM card can be inserted, Integrated radio audio facility which provides the radio telecasting to the rider inside the helmet, hands-free calling facility as the rider can listen from inside the helmet. The helmet is also provided with a gyroscope and accelerometer facility which measures the angle and the speed of the vehicle and can be displayed on the screen inside the helmet.

The power requirements of the motorcycle helmet is fulfilled with the help of the high-capacity battery pack which is embedded in the helmet to provide reasonable service life between charges. The battery pack is rechargeable which has to be charged at regular intervals. The size and weight of the battery is kept in mind as the helmet must not become heavy after the rider wears it as it might cause adverse effects on the motorcycle rider which might damage the neck. The shape of battery pack allows it to fit low and close around the base of the rider's neck extending substantially from ear-to-ear, while the outer surface conforms to the helmet outline. By positioning battery pack low and close around the base of the rider's neck, the moment of inertia of battery pack is minimized relative to the normal turning and tilting motion of the rider's head. Battery pack is easily replaceable using conventional plug-in connectors and releasable catches.

1. An augmented helmet system having capabilities to display various information to the user comprising:
a. an helmet outer shell;
b. a conventional face shield attached to the helmet shell;
e. a chin bar and chin strap located below the face shield;
d. a heads up display system mounted to the inside surface of the chin bar Which can display information to the user including navigational information, bike's speed and location and the information about the vehicles which are close to the user;

2. The augmented helmet system of as claimed in claim 1, wherein the heads-up display comprises of a virtual image display unit consisting of a liquid crystal display (LCD), backlight, collimating optics and magnification optics encased in a single device.

3. The augmented helmet system of as claimed in claim 1, wherein the helmet further includes situational awareness feature which enables the rider to be aware of the vehicles which are travelling along on the same location and direction.

4. The augmented helmet system of as claimed in claim 1, wherein the helmet further includes a five inch wide angle rear view camera to capture the panorama view of the area behind the rider that can be enhanced with the help of the synapse vision enhancement feature that pros ides the true to life imaging of the rear view panorama display to the rider.

5. The augmented helmet system of as claimed in claim 1, wherein the helmet further includes global positioning system (GPS) navigation to display the location and the direction of the way in which the rider is travelling; Bluetooth technology which can connect the helmet with other devices through Bluetooth; internet phone chipset that helps in establishing the communication; GSM sim card slot in which a SIM card can be inserted for further communication; Integrated radio which provides the radio telecast to the rider inside the helmet, hands-free calling facility which enables the rider to communicate without having to use the cellphone, Sirius XM radio for commercial-free music, live play-by-play sports, the biggest news and talk; Gyroscope to measure the angle of the bike; and the accelerometer to measure the speed of the bike.

6. The augmented helmet system of as claimed in claim 1, wherein the helmet is powered by a high capacity replaceable and rechargeable battery pack that is attached to the helmet outer shell in a region proximal the base of the user's neck extending substantially from ear-to-ear.

7. The augmented helmet system of as claimed in claim 1, wherein the ventilation facility inside the helmet is provided with the help of conventional ventilation intakes which are adjustable to allow a controlled amount of air to enter the helmet for the purpose of reducing fogging of face shield.

8. The augmented helmet system of as claimed in claim 1, wherein the ventilation for the rider is also facilitated through the air passageway having an intake port and an exhaust port along with plurality of vents like super vent, mount vent, side vent and rear vent.

9. The augmented helmet system of as claimed in claim 6, wherein the battery pack has an interior cooling ventilation system that provides ventilation facility to the battery pack and cools it down.

13. The helmet system of claim 11, further comprising

10. The augmented helmet system of as claimed in claim 1, wherein the interior of the helmet is made of 3D laser cut foam with superior quality which gives the rider's head a perfect fit inside the helmet.

11. The augmented helmet system of as claimed in claim 1, wherein the interior of the helmet is constructed by the conventional materials formed of expanded polystyrene or polypropylene foam (EPS).

12. The augmented helmet system of as claimed in claim 1, wherein the'exterior of the helmet is constructed using a homogeneous plastic such as polyamide, polyethylene or polycarbonate, car from a composite material such as fiberglass, aramid, carbon fiber or other composites.
